(19) United States
(12) Patent Application Publication
(10) Pub. No.: US 2023/0167532 A1
(43) Pub. Date: Jun. 1, 2023

(54) SLURRY COMPOSITION FOR SUSPENSION PLASMA THERMAL SPRAY, PREPARATION METHOD THEREFOR, AND SUSPENSION PLASMA THERMAL SPRAY COATING FILM

(71) Applicants: Sunghoon LEE, Anseong-si (KR); Chae-jong JUNG, Anseong-si (KR); Donghun JEONG, Anseong-si (KR); Changseong LIM, Anseong-si (KR); Jaeim JEONG, Anseong-si (KR); Seong Sik BANG, Anseong-si (KR)

(72) Inventors: Sunghoon LEE, Anseong-si (KR); Chae-jong JUNG, Anseong-si (KR); Donghun JEONG, Anseong-si (KR); Changseong LIM, Anseong-si (KR); Jaeim JEONG, Anseong-si (KR); Seong Sik BANG, Anseong-si (KR)

(21) Appl. No.: 17/921,882

(22) PCT Filed: Feb. 17, 2021
(86) PCT No.: PCT/KR2021/002007

§ 371 Date: Oct. 27, 2022

(30) Foreign Application Priority Data
May 6, 2020 (KR) 10-2020-0054045

(51) Int. Cl. C23C 4/11

(52) U.S. Cl. CPC C23C 4/11; C23C 4/134

(57) ABSTRACT

Proposed are a slurry composition for suspension plasma thermal spray, a preparation method therefor, and a suspension plasma thermal spray coating film. When the slurry composition is used to form a thermal spray coating film, the thermal spray coating film can be stably applied to applications used in a corrosive environment because no changes occur in content of oxygen and fluorine in the thermal spray coating film. In addition, when forming the coating film, since various crystal structures can be formed under control, the coating film can be used in various environments requiring corrosion resistance. In addition, the slurry composition can inhibit formation of cracks and pores that frequently occur in existing thermal spray coating films, thereby allowing for formation of a denser thermal spray coating film than the existing thermal spray coating film.

### TECHNICAL FIELD

The present invention relates to a slurry composition for suspension plasma thermal spray, a preparation method therefor, and a suspension plasma thermal spray coating film. More particularly, the present invention relates to a slurry composition for suspension plasma thermal spray, the composition being applicable to components used in corrosive environments, such as manufacturing equipment for semiconductor or display devices, chemical plants, power plants, and the like, to a preparation method therefor, and to a suspension plasma thermal spray coating film.

### BACKGROUND ART

Components of equipment used in corrosive environments require a coating with excellent corrosion resistance for improvement in durability of the equipment. Particularly, vacuum plasma equipment has been widely used in processes for the implementation of semiconductor devices or other ultra-fine structures.

Vacuum plasma equipment uses high-temperature plasma for implementation of ultra-fine structures or etching of semiconductor devices. Therefore, a chamber and its internal components can be easily damaged since high-temperature plasma is generated inside the vacuum plasma equipment. In addition, the chamber and its internal components are likely to be contaminated by certain elements and contaminant particles generated in the chamber and from the surface of its internal components.

In particular, in the case of plasma etching equipment, since reactive gases including F, Cl, and the like are injected into the plasma atmosphere, the inner wall and internal components of the chamber are exposed to an extremely corrosive environment. Such corrosion primarily causes damage to the chamber and its internal components and secondarily causes a problem of generating contaminant particles, thereby increasing the defect rate and deteriorating the quality of products produced by the process performed in the chamber.

The vacuum plasma chamber and the internal components there are selected depending on many factors such as corrosion resistance, processability, ease of manufacture, price, insulation, and the like. Generally, metal materials such as a stainless steel alloy, aluminum (or an alloy of aluminum), titanium (or an alloy of titanium), and the like and ceramic materials such as SiO₂, Si, Al₂O₃, and the like are used as chamber materials. Preferably, the chamber is manufactured in the form of a single body sequentially through single-body casting and processing of the inside of the body. However, when taking into account the productivity and manufacturing cost, the chamber may be manufactured by assembling several components. For components made of an Al alloy, the technique of forming an Al₂O₃ ceramic coating film on a surface of a base material using an anodizing process has been widely introduced. However, the ceramic coating film formed by the technique has a problem of having multiple defects inside. Therefore, the technique has disadvantages that it is difficult to obtain a coating film with high hardness and corrosion resistance, and contaminant particles are generated in a large amount.

In the case of many other metal materials and ceramic materials to which the anodizing process is difficult to be applied, the materials are protected by formation of a protective film made of an anti-corrosive material (for example, Al₂O₃, Y₂O₃, Al₂O₃/Y₂O₃, ZrO₂, AlC, TiN, AlN, TiC, MgO, CaO, CeO₂, TiO₂, BxCy, BN, SiO₂, SiC, and the like) that does not generate a relatively less amount of contaminant. Recently, there have been cases that an Al alloy material that is anodizable is protected by formation of a protective film made of a heterogeneous ceramic material. The representative method of forming a protective film using a heterogeneous ceramic material is an atmospheric plasma spraying method.

Generally, the atmospheric plasma spraying method is a technology of forming a coating film (covering film) by injecting a metal or ceramic powder into a high-temperature heat source to heat the metal or ceramic powder and then laminating the semi-molten or fully molten metal or ceramic to the surface of a base material. Depending on the types of heat source, the coating method is called a plasma thermal spray coating or a high velocity oxygen fuel (HVOF) coating method. Currently, oxides such as yttrium oxide (Y₂O₃) or aluminum oxide (Al₂O₃) are the most widely used thermal spray coating materials that are commercially available (see Patent Document 0001).

Such a thermal spray coating layer using an oxide such as yttrium oxide (Y₂O₃) or aluminum oxide (Al₂O₃) reacts with a halogen-based gas on the surface thereof, causing a change in the plasma concentration in an etching device. Therefore, the thermal spraying coating layer has problems of destabilizing the etching process (process shift phenomenon), generating particles, and increasing the time taken for the process to be stabilized.

Hence, to solve the above problems, there has been a spreading tendency to use yttrium fluoride coating having relatively low reactivity with a halogen-based gas (see Patent Documents 0002 and 0003). However, since the yttrium fluoride coating formed using the atmospheric plasma spraying method has more surface cracks and lower hardness than yttrium oxide coating, the yttrium fluoride coating is easily etched. Since this shortens the replacement cycle of parts, the yttrium fluoride coating is still problematic from a long-term point of view.

Therefore, development in corrosion-resistant coating films which can be stably applied to corrosive environments and has excellent plasma resistance and mechanical properties compared to the yttrium oxide thermal spray coating film or yttrium fluoride thermal spray coating film that has been used is requested industrially.

### DOCUMENT OF RELATED ART

### Patent Document

(Patent Document 0001) Japanese Patent No. 4006596 (published on: Apr. 2, 2004)

(Patent Document 0002) Japanese Patent No. 3523222 (published on: Apr. 19, 2002)

(Patent Document 0003) Korean Patent Registration No. 1911959 (published on: May 21, 2013)

### DISCLOSURE

### Technical Problem

The present invention has been made to solve the problems occurring in the related art, a main objective of the present invention is to provide a slurry composition for suspension plasma thermal spray, the slurry composition being stably applicable to a corrosive environment and enabling formation of various crystal structures under control. The slurry composition can be applied to various environments in which corrosion resistance is required and enables formation of a denser thermal spray coating film than conventional thermal spray coating films.

In addition, another objective of the present invention is to provide a method for preparing the slurry composition for suspension plasma thermal spray.

In addition, a further objective of the present invention is to provide a suspension plasma thermal spray coating film for coating equipment and its components used in corrosive environments such as semiconductor or display manufacturing equipment, chemical plants, power plants, the suspension plasma thermal spray coating film being formed from the mentioned above slurry composition for suspension plasma thermal spray.

### Technical Solution

In order to accomplish the above objectives, an embodiment of the present invention provides a slurry composition for suspension plasma thermal spray. The slurry composition includes a solvent and a thermal spray powder selected from the group consisting of: a thermal spray powder including a Y₂O₃ powder and a YF₃ powder; a thermal spray powder including a Y₂O₃ powder and a YOF powder; a thermal spray powder including a YF₃ powder and a YOF powder; and a thermal spray powder including a Y₂O₃ powder, a YF₃ powder, and a YOF powder. When the thermal spray powder includes the Y₂O₃ powder and the YF₃ powder, the weight ratio thereof is in a range of 1:0.1 to 9, when the thermal spray powder includes the Y₂O₃ powder and the YOF powder, the weight ratio thereof is in a range of 1:0.1 to 9, when the thermal spray powder includes the YF₃ powder and the YOF powder, the weight ratio thereof is in a range of 1:0.1 to 9, and when the thermal spray powder includes the Y₂O₃ powder, the YF₃ powder, and the YOF powder, the weight ratio thereof is in a range of 1:0.1 to 9:0.1 to 9.

In a preferred embodiment of the present invention, the slurry composition for suspension plasma thermal spray may include the solvent and the thermal spray powder in a weight ratio of 100 parts of the solvent to 10 to 50 parts of the thermal spray powder.

In a preferred embodiment of the present invention, the thermal spray powder may have an average particle size in a range of 100 nm to 10 μm.

In a preferred embodiment of the present invention, the solvent may include at least one selected from the group consisting of water, alcohol, ether, ester, and ketone.

Another embodiment of the present invention provides a method for preparing a slurry composition for suspension plasma thermal spray. The method includes: (a) dispersing each of at least two kinds of powders selected from the group consisting of a Y₂O₃ powder, a YF₃ powder, and a YOF powder into a solvent to obtain two or more kinds of dispersions; and (b) mixing the two or more kinds of dispersions. In the (b) mixing, the mixing weight ratio is in a range of 1:0.1 to 9 when the two or more kinds of dispersions are a Y₂O₃ dispersion and a YF₃ dispersion, the mixing weight ratio is in a range of 1:0.1 to 9 when the two or more kinds of dispersions are a Y₂O₃ dispersion and a YOF dispersion, the mixing weight ratio is in a range of 1:0.1 to 9 when the two or more kinds of dispersions are a YF₃ dispersion and a YOF dispersion, and the mixing weight ratio is in a range of 1:0.1 to 9:0.1 to 9 when the two or more kinds of dispersions are a Y₂O₃ dispersion, a YF₃ dispersion, and a YOF dispersion.

In another preferred embodiment of the present invention, in the (a) dispersing, a weight ratio of the solvent to the powder is 100 parts to 10 to 50 parts.

In another preferred embodiment of the present invention, in the (a) dispersing, the powders may have an average particle size in a range of 100 nm to 10 μm.

In another preferred embodiment of the present invention, in the (a) dispersing, the solvent may include at least one selected from the group consisting of water, alcohol, ether, ester, and ketone.

A further embodiment of the present invention provides a suspension plasma thermal spray coating film formed by suspension plasma thermal spray using the slurry composition for suspension plasma thermal spray.

In a further preferred embodiment of the present invention, the suspension plasma thermal spray coating film may include 10% to 60% by weight of yttrium (Y), 1% to 20% by weight of oxygen (O), and 20% to 70% by weight of fluorine (F) with respect to a total weight of all of the elements constituting the coating film.

In a further preferred embodiment of the present invention, the suspension plasma thermal spray coating film may have a thickness in a range of 10 μm to 200 μm.

In a further preferred embodiment of the present invention, the suspension plasma thermal spray coating film may have a porosity of less than 2% measured according to ASTM E2109.

In a further preferred embodiment of the present invention, the suspension plasma thermal spray coating film may include a monoclinic crystal structure and/or a rhombohedral crystal structure.

### Advantageous Effects

When the slurry composition for suspension plasma thermal spray, according to the present invention, is used to form a thermal spray coating film, the ratio of an oxygen component and a fluorine component in the thermal spray coating film is not likely to change. Therefore, the thermal spray coating film can be stably applied to a corrosive environment. In addition, the slurry composition enables formation of various crystal structures under control and inhibits generation of cracks and pores that generally occurred in conventional thermal spray coating films, thereby enabling formation of a relatively highly dense thermal spray coating film applicable to various corrosive environments, compared to conventional thermal spray coating films.

Therefore, the suspension plasma thermal spray coating film according to the present invention has a relatively high hardness and a relatively low porosity compared to conventional coating films made of yttrium oxide or yttrium fluoride. For this reason, the thermal spray coating film according to the present invention has improved resistance to plasma, which extends the replacement cycle of components coated with the thermal spray coating film.

### DESCRIPTION OF DRAWINGS

FIG. 1 shows scanning electron microscopy (SEM) images of thermal spray coating films manufactured in Examples 1 to 6, in which (a), (b), (c), (d), (e), and (f) represent thermal spray coating films manufactured in Example 1, 2, 3, 4, 5, and 6, respectively; and

FIG. 2 shows SEM images of thermal spray coating films manufactured in Comparative Examples 1 to 8, in which (a), (b), (c), (d), (e), (f), and (g) represent thermal spray coating films manufactured in Comparative Example 1, 2, 3, 4, 5, 6, 7, and 8, respectively.

### BEST MODE

Unless otherwise defined, all technical and scientific terms used herein have the same meaning as commonly understood by one of ordinary skill in the art to which this invention belongs. In general, the nomenclature used herein is well known and commonly used in the art.

Throughout this specification, when an element is referred to as “including” an element, it is understood that the element may include other elements as well, without departing from the other elements unless specifically stated otherwise.

In one aspect, the present invention relates to a slurry composition for suspension plasma thermal spray. The slurry composition includes a solvent and a thermal spray powder selected from the group consisting of: a thermal spray powder including a Y₂O₃ powder and a YF₃ powder; a thermal spray powder including a Y₂O₃ powder and a YOF powder; a thermal spray powder including a YF₃ powder and a YOF powder; and a thermal spray powder including a Y₂O₃ powder, a YF₃ powder, and a YOF powder. When the thermal spray powder includes the Y₂O₃ powder and the YF₃ powder, the weight ratio thereof is in a range of 1:0.1 to 9, when the thermal spray powder includes the Y₂O₃ powder and the YOF powder, the weight ratio thereof is in a range of 1:0.1 to 9, when the thermal spray powder includes the YF₃ powder and the YOF powder, the weight ratio thereof is in a range of 1:0.1 to 9, and when the thermal spray powder includes the Y₂O₃ powder, the YF₃ powder, and the YOF powder, the weight ratio thereof is in a range of 1:0.1 to 9:0.1 to 9.

The slurry composition for suspension plasma thermal spray, according to the present invention, is a material used in suspension plasma thermal spray, which forms a plasma in a vacuum or the atmosphere. The slurry composition for suspension plasma thermal spray may include the solvent and at least two kinds of the thermal spray powders selected from the group consisting of the Y₂O₃ powder, the YF₃ powder, and the YOF powder.

The slurry composition for suspension plasma thermal spray, according to the present invention, contains at least two kinds of the thermal spray powders selected from the group consisting of the Y₂O₃ powder, the YF₃ powder, and the YOF powder in a certain ratio into the solvent to be used as the material of suspension plasma thermal spray. As a result, the ratio of an oxygen component and a fluorine component contained in a thermal spray coating film does not change. Therefore, a thermal spray coating film formed by suspension plasma thermal spray can be stably applied to a corrosive environment. At the same time, the slurry composition enables formation of various crystal structures under control and inhibits generating of cracks and pores that occurred in an atmospheric plasma spraying (APS) method, thereby enabling formation of a highly dense thermal spray coating film applicable to various corrosive environments, compared to conventional thermal spray coating film.

The thermal spray powder includes at least two kinds of the powders selected from the group consisting of the Y₂O₃ powder, the YF₃ powder, and the YOF powder. Thus, the thermal spray powders may include the Y₂O₃ powder and the YF₃ powder or the Y₂O₃ powder and the YOF powder, or the YF₃ powder and the YOF powder or the Y₂O₃ powder, the YF₃ powder, and the YOF powder.

In the case of the thermal spray powder, when the thermal spray powder includes the Y₂O₃ powder and the YF₃ powder, the weight ratio thereof may be in the range of 1:0.1 to 9, and preferably the range of 1:0.1 to 4. When the thermal spray powder includes the Y₂O₃ powder and YOF powder, the weight ratio thereof may be in the range of 1:0.1 to 9 and preferably the range of 1:0.1 to 5. When the thermal spray powder includes the YF₃ powder and YOF powder, the weight ratio thereof may be in the range of 1:0.1 to 9, and preferably the range of 1:0.1 to 2. In addition, when the thermal spray powder includes the Y₂O₃ powder, the YF₃ powder, and the YOF powder, the weight ratio thereof may be in the range of 1:0.1 to 9:0.1 to 9, and preferably the range of 1:0.1 to 4:0.1 to 5.

When the content of the thermal spray powder is unsatisfied the designated range, there may be a problem that the synergistic effect obtained by mixing each of the thermal spray powders is minimal.

The powder may have an average particle size in a range of 100 nm to 10 μm, and preferably a range of 1 μm to 5 μm. When the average particle size of the powder is less than 100 nm, due to the low flowability of the slurry and a problem in film-forming rate, the thermal spray coating film cannot be evenly implemented. In addition, the slurry composition may be oxidized or scattered before reaching the plasma zone, so that thermal spray coating yield may be reduced. When the average particle size of the powder exceeds 10 μm, due to the powders being coarse, there may be a problem that suspension plasma thermal spray coating cannot be performed.

On the other hand, the solvent serving as a dispersion medium of the powder may be at least one selected from water and an organic solvent. That is, as the solvent, water may be used alone, water may be used in combination with the organic solvent, or the organic solvent may be used alone.

The organic solvent is preferably selected in consideration of harmfulness or environmental impact, and examples of the organic solvent include alcohol, ether, ester, and ketone. Specifically, monohydric or dihydric alcohol having 2 to 6 carbon atoms, ether having 3 to 8 carbon atoms such as ethyl cellosolve, glycol ether having 4 to 8 carbon atoms such as dimethyl diglycol, glycol ester having 4 to 8 carbon atoms such as ethyl cellosolve acetate and butyl cellosolve acetate, cyclic ketones having 6 to 9 carbon atoms such as isophorone, and the like is preferable. The organic solvent is particularly preferably a water-soluble organic solvent that can be mixed with water in a perspective of combustibility or safety.

Such a solvent can be selected in consideration of a degree of dispersion and flowability of the thermal spray powder being used. In addition, when the oxygen content of the thermal spray coating film is required to be increased, water may be preferably used. When an increase in the oxygen content of the thermal spray coating film is required to be inhibited, the organic solvent may be preferably used.

The slurry composition according to the present invention may include the solvent and the powder in a weight ratio of 100 parts of the solvent to 10 to 50 parts of the thermal spray powder. When the slurry composition includes less than 10 parts by weight of the powder with respect to 100 parts by weight of the solvent, since a film-forming rate is excessively slow, the processing and coating of a product take longer. As a result, there may be a problem that due to heat, the risk of deformation naturally increases. When the slurry composition includes more than 50 parts by weight of the powder with respect to 100 parts by weight of the solvent, the powder cannot be dispersed evenly overall. As a result, there may be a problem that a transfer tube, a nozzle, and the like are clogged during coating, or many un-melted particles may be present on the coating surface of the product.

In addition, in the slurry composition according to the present invention, other components such as an aggregation inhibitor and a particulate additive may be mixed, as needed, to the extent that the performance of the slurry composition is not interfered with.

The aggregation inhibitor is preferably a surfactant and the like. Since the zeta potential of each of YF₃ and YOF is positive, the aggregation inhibitor is preferably an anionic surfactant. Particularly, it is preferable to use a polyethyleneimine-based anionic surfactant, a polycarboxylic acid-type polymer-based anion surfactant, and the like. When the solvent includes water, the anionic surfactant is preferably used. However, when the solvent includes only the organic solvent, a nonionic surfactant may also be used. The slurry composition may include 3% by weight or less of the aggregation inhibitor, and preferably 1% by weight or less in particular. In addition, the slurry composition may include 0.01% by weight or more of the aggregation inhibitor, and rather preferably 0.03% by weight or more in particular.

In addition, the particulate additive, which is added for the prevention of aggregation or sedimentation of the thermal spray powder, may include a rare-earth hydroxide, a rare-earth carbonate, and the like. An average particle diameter [D50 (on a volume basis)] of the particulate additive is preferably 1/10 or less of an average particle diameter [D50 (on a volume basis)] of the thermal spray powder. The slurry composition may include 5% by weight or less of the particulate additive, and preferably 4% by weight or less in particular. In addition, the slurry composition may include 0.1% by weight or more of the particulate additive, and rather preferably 2% by weight or more in particular.

In another aspect, the present invention relates to a method for preparing a slurry composition for suspension plasma thermal spray. The method includes: (a) dispersing each of at least two kinds of powders selected from the group consisting of a Y₂O₃ powder, a YF₃ powder, and a YOF powder into a solvent to obtain two or more kinds of dispersions; and (b) mixing the two or more kinds of dispersions. In the (b) mixing, the mixing weight ratio is in a range of 1:0.1 to 9 when the two or more kinds of dispersions are a Y₂O₃ dispersion and a YF₃ dispersion, the mixing weight ratio is in a range of 1:0.1 to 9 when the two or more kinds of dispersions are a Y₂O₃ dispersion and a YOF dispersion, the mixing weight ratio is in a range of 1:0.1 to 9 when the two or more kinds of dispersions are a YF₃ dispersion and a YOF dispersion, and the mixing weight ratio is in a range of 1:0.1 to 9:0.1 to 9 when the two or more kinds of dispersions are a Y₂O₃ dispersion, a YF₃ dispersion, and a YOF dispersion.

In the method for preparing the slurry composition for suspension plasma thermal spray according to the present invention, the two or more kinds of dispersions are prepared by dispersing each of at least two kinds of the powders selected from the group consisting of the Y₂O₃ powder, the YF₃ powder, and the YOF powder into the solvent and by mixing the two or more kinds of the dispersions being prepared in a certain ratio to prepare the slurry composition for suspension plasma thermal spray. As a result, compared to the conventional manufacturing method of mixing two or more types of thermal spray powders and then dispersing the same in a solvent, it is easy to change the mixing weight ratio depending on the application environment, and it is convenient for the management of the prepared slurry composition in the method of the present invention.

In the (a) dispersing, each of the two or more kinds of dispersions are provided by dispersing each of at least two kinds of the powders selected from the group consisting of the Y₂O₃ powder, the YF₃ powder, and the YOF powder into the solvent.

In this case, the dispersion may include 10 to 50 parts by weight of the Y₂O₃ powder, the YF₃ powder, or the YOF powder with respect to 100 parts by weight of the solvent. When the dispersion includes less than 10 parts by weight of the powder with respect to 100 parts by weight of the solvent, since a film-forming rate is excessively slow, the processing and coating of a product take longer. As a result, there may be a problem that due to heat, the risk of deformation naturally increases. When the slurry composition includes more than 50 parts by weight of the powder with respect to 100 parts by weight of the solvent, the powder cannot be dispersed evenly overall. As a result, there may be a problem that a transfer tube, a nozzle, and the like are clogged during coating, or many un-melted particles may be present on the coating surface of the product.

As described above, when two or more kinds of mixtures, in which the Y₂O₃ powder, the YF₃ powder, or the YOF powder is dispersed in the solvent, are provided, the slurry composition for suspension plasma thermal spray is prepared by mixing the two or more kinds of dispersion [in the (b) mixing].

In this case, the mixture of the two or more kinds of dispersion may be a mixture of the Y₂O₃ dispersion and the YF₃ dispersion, may be a mixture of the Y₂O₃ dispersion and the YOF dispersion, may be a mixture of the YF₃ dispersion and the YOF dispersion, and may be a mixture of the Y₂O₃ dispersion, the YF₃ dispersion, and the YOF dispersion.

In this case, when the mixture of the dispersions is the mixture of the Y₂O₃ dispersion and the YF₃ dispersion, the weight ratio thereof may be in the range of 1:0.1 to 9, and preferably the range of 1:0.1 to 4. When the mixture of the dispersions is the mixture of the Y₂O₃ powder and YOF powder, the weight ratio thereof may be in the range of 1:0.1 to 9, and preferably the range of 1:0.1 to 5. When the mixture of the dispersions is the mixture of the YF₃ powder and YOF powder, the weight ratio thereof may be in the range of 1:0.1 to 9, and preferably the range of 1:0.1 to 2. In addition, when the mixture of the dispersions is the mixture of the Y₂O₃ powder, the YF₃ powder, and the YOF powder, the weight ratio thereof may be in the range of 1:0.1 to 9:0.1 to 9, and preferably the range of 1:0.1 to 4:0.1 to 5.

When the content of the thermal spray powder is unsatisfied the designated range, there may be a problem that the synergistic effect obtained by mixing each of the thermal spray powders is minimal.

When the two or more kinds of dispersions are mixed as described above, the mixed mixture can be evenly ground using mechanical grinding.

The grinding can be applied without limitation provided that the grinding method is applicable in the art at room temperature and atmospheric pressure. Preferably a mechanical milling method can be used, and specific methods thereof include ball milling, planetary ball milling, attrition milling, shaker milling, and the like.

The powders contained in the mixture may have an average particle size in a range of 100 nm to 10 μm, and preferably a range of 1 μm to 5 μm. When the average particle size of the powders contained in the mixture is less than 100 nm, due to the low flowability of the slurry, the thermal spray coating film cannot be evenly implemented. In addition, the slurry composition may be oxidized or scattered before reaching the plasma zone, so that the thermal spray coating yield may be reduced. When the average particle size of the powders contained in the mixture exceeds 10 μm, since the powder is coarse, it is not completely melted when injected into the plasma, thereby generating an un-melted portion in the coating. As a result, there may be a problem that a dense thin film cannot be obtained.

On the other hand, in the method for preparing the slurry composition according to the present invention, after the (a) dispersing, other components such as an aggregation inhibitor and a particulate additive may be mixed, as needed, to the extent that the performance of the slurry composition is not interfered with.

The method for preparing the slurry composition for suspension plasma thermal spray, according to the present invention, has advantages in that component ratios or conditions of a material of suspension plasma thermal spray can be easily modified according to the plasma-resistive environment, the prepared material can be easily managed, and the manufactured thermal spray coating film can also be formed into the high-quality dense coating.

In another aspect, the present invention relates to a suspension plasma thermal spray coating film which is formed on a substrate with the use of the slurry composition for the suspension plasma by suspension plasma thermal spray.

In the present invention, the suspension plasma thermal spray may include a typical suspension plasma thermal spraying method which obtains a thermal spray coating film by injecting the slurry composition for suspension plasma thermal spray into a plasma jet, heating, accelerating, and depositing the same on a substrate.

In the suspension plasma thermal spray, gases for the formation of the plasma are preferably a mixture gas combined with two or more kinds of gases selected from an argon gas, a hydrogen gas, a helium gas, and a nitrogen gas. Particularly, a mixture of two gases, the argon gas and the nitrogen gas, a mixture of three gases, the argon gas, the hydrogen gas, and the helium gas, or a mixture of four gases, the argon gas, the hydrogen gas, the helium gas, and the nitrogen gas are preferable.

In the case of an argon/hydrogen plasma thermal spray, a specific example of the suspension plasma thermal spray includes an atmospheric suspension plasma thermal spray using the mixture gas of argon and hydrogen in the atmosphere. Thermal spraying conditions, such as thermal spray distance or a current value, a voltage value, an amount of the argon gas supplied, an amount of the hydrogen gas supplied, and the like, may be set by the use of the thermal spray component. The slurry composition according to the present invention is filled in a thermal spray material feeder in a predetermined amount. Then the slurry composition is supplied to the tip of a plasma thermal spray gun by a carrier gas (argon) using a hose. The supplied slurry composition is continuously supplied into the middle of the plasma flame, so that the thermal spray powder contained in the slurry composition is melted and liquefied and becomes a liquid frame by the power of the plasma jet. As the liquid frame comes into contact with the substrate, the molten thermal spray powder is adhered, solidified, and deposited. With this principle, the thermal spray coating film can be formed within a predetermined coating range on the substrate by moving the frame left and right, and up and down.

In such suspension plasma spray, the solvent in the slurry composition is vaporized in the plasma. For this reason, by using the slurry composition of the present invention, fine particles that was unable to be melted in the atmospheric plasma spraying method that supplies a thermal spray material in a solid state can be melted. In addition, by forming the thermal spray coating film with the use of aligned droplets having a constant size without coarse particles, various crystal structures can be formed, thereby enabling the formation of a dense thermal spray coating film with high-quality.

On the other hand, the substrate for coating the thermal spray coating film is not particularly limited. For example, a material or a structure of the substrate is not particularly limited provided that it is the substrate having desired resistance due to the thermal spray material. Specifically, the substrate may be selected from stainless steel, aluminum, nickel, chromium, zinc, alloys thereof, alumina, aluminum nitride, silicon nitride, silicon carbide, quartz glass, and the like which constitute the component of semiconductor manufacturing apparatus and the like.

In addition, it is preferable to process the surface of the substrate in accordance with the working standard of ceramic sprayed coatings prescribed in JIS H 9302 before plasma spraying. For example, after removing rust, oils and fats, and the like from the surface of the substrate, the surface can be roughened by spraying grinding particles such as Al₂O₃ and SiC and can be pre-treated in a state to which the thermal spray coating film can be easily adhered.

The thermal spray coating film manufactured as described above may be formed to have a thickness in a range of 10 μm to 200 μm. When the thickness of the thermal spray coating film is less than 10 μm, it is difficult to coat evenly overall due to the influence of the surface roughness of the substrate. As a result, there may be problems in that an even coating film cannot be formed, and the surface of the substrate may be partially exposed by a cleaning operation. When the thickness of the thermal spray coating film exceeds 200 μm, the coating may have a problem of being peeled off due to a large amount of thermal shock and stress.

In general, the Y₂O₃ powder is most commonly used material for suspension plasma thermal spray. However, in the case of coating using the Y₂O₃ powder, a component of the surface is changed to YF₃ or YOF due to the influence of process gas in the semiconductor chamber. Thus, the coating process can be performed when the surface becomes stabilized after the progress of the changing process. For this reason, when the YF₃ powder or the YOF powder is used in the coating from the beginning, a time for such surface stabilization can be shortened, and change in the surface occurs less, which can be an opportunity to reduce particle generation. However, it is difficult to use the suitable powder since patterns in which the surface is changed are different, and the degree of the change is also different depending on the process.

Hence, the thermal spray coating film of the present invention is manufactured by sequentially analyzing the coating after its use in processes and by using the slurry composition as the suspension plasma thermal spray material. The two or more kinds of the most similar powders among the Y₂O₃ powder, the YF₃ powder, and the YOF powder are mixed in a specific ratio to prepare the slurry composition. As a result, the time for stabilization and particle generation can be reduced. In addition, the coating can be controlled in various ratios of the Y₂O₃, the YF₃, and the YOF, can be easily manufactured to form various crystal structures, and thus can be appropriately applied to various process conditions.

The thermal spray coating film of the present invention may include a monoclinic crystal structure and/or a rhombohedral crystal structure, thereby having relatively high density and hardness and being capable of coating which includes fluoride having strong plasma etching resistance. In addition, a relatively highly dense thermal spray coating film with a porosity of 2% or less, and preferably 1.5% or less, which is measured according to ASTM E2109, can be obtained.

In addition, the thermal spray coating film may include 10% to 60% by weight of yttrium (Y), 1% to 20% by weight of oxygen (O), and 20% to 70% by weight of fluorine (F) with respect to a total weight of all of the elements constituting the coating film. The thermal spray coating film having such contents of constituent elements can be stably applied to various environments in which corrosion resistance is required and at the same time, can be formed into a coating film having a low porosity.

The suspension plasma thermal spray coating film according to the present invention has a relatively high hardness and a relatively low porosity at the same time compared to the conventional coating of yttrium oxide or yttrium fluoride. In addition, since the plasma resistance is enhanced, the replacement cycle of the thermal spray coating film component can be extended.

The synthesis method of the present invention as described above will be described in more detail through the following examples, but the present invention is not limited thereto.

### Example 1

1-1: Preparation of Slurry Composition

A Y₂O₃ dispersion and a YF₃ dispersion which were respectively dispersed with 30 parts by weight of a Y₂O₃ powder (average particle size: 5 μm) and 30 parts by weight of a YF₃ powder (average particle size: 5 μm) with respect to 100 parts by weight of water were mixed in mixing ratios shown in Table 1 below. Then, a slurry composition was prepared by evenly dispersing the mixed dispersions using milling equipment.

1-2: Manufacturing of Thermal Spray Coating Film

A substrate to form a thermal spray coating film was placed in a chamber which was controlled to be in a nitrogen atmosphere and a thermal spray gun was placed in the chamber. Then an argon gas, a hydrogen gas, and a nitrogen gas were injected into the thermal spray gun as mainstream gases to produce a plasma. A distance between the thermal spray gun and the substrate was adjusted to 76 mm. While supplying the slurry composition prepared in Example 1-1 to the produced plasma at a flow rate of 324 ml/min, a thermal spray coating film was formed to have a thickness of 100 μm.

### Examples 2 to 6

A slurry composition and a thermal spray coating film were prepared in the same manner as in Example 1. However, after the slurry composition was prepared by mixing in ratios of dispersions shown in Table 1 below, the thermal spray coating film was formed.

### Comparative Example 1

1-1: Preparation of Thermal Spray Material

A Y₂O₃ powder (average particle size: 5 μm), a YF₃ powder (average particle size: 5 μm), and a YOF powder (average particle size: 5 μm) were mixed in ratios shown in Table 1 below, and then a thermal spray material was prepared by evenly mixing the mixed powders using milling equipment.

1-2: Manufacturing of Thermal Spray Coating Film

A substrate to form a thermal spray coating film was placed in a chamber and a thermal spray gun was placed in the chamber. Then an argon gas and a hydrogen gas were injected into the thermal spray gun as mainstream gases to produce a plasma. The distance between the thermal spray gun and the substrate was adjusted to 130 mm. While supplying the thermal spray material prepared in Comparative Example 1-1 to the produced plasma at a flow rate of 20 g/min, a thermal spray coating film manufactured by atmospheric plasma spraying method was formed to have a thickness of 100 μm.

### Comparative Examples 2 to 8

A thermal spray material and a thermal spray coating film were prepared in the same manner as in Comparative Example 1. However, after the thermal spray material was prepared by mixing in ratios shown in Table 1 below, the thermal spray coating film manufactured by atmospheric plasma spraying method was formed.

TABLE 1

| | | Weight ratio of thermal spray powder | | |
|---|---|---|---|---|
| | | of slurry composition | | |
| Classification | | Y₂O₃ | YF₃ | YOF |
| Example | 1 | 1 | 1 | — |
| Example | 2 | 1 | 4 | — |
| Example | 3 | — | 3 | 1 |
| Example | 4 | 1 | 1 | 1 |
| Example | 5 | 1 | — | 5 |
| Example | 6 | — | 1 | 3 |
| Comparative | 1 | 1 | 1 | — |
| Example | | | | |
| Comparative | 2 | 1 | — | 1 |
| Example | | | | |
| Comparative | 3 | 1 | — | 3 |
| Example | | | | |
| Comparative | 4 | 1 | — | 4 |
| Example | | | | |
| Comparative | 5 | 1 | — | 5 |
| Example | | | | |
| Comparative | 6 | 7 | 3 | — |
| Example | | | | |
| Comparative | 7 | 8 | 2 | — |
| Example | | | | |
| Comparative | 8 | — | 3 | 1 |
| Example | | | | |

### Experimental Example 1: Measurement of Components of Thermal Spray Coating Film

In order to analyze the changes in the Y, O, and F component content in each of the thermal spray coating films manufactured in Examples 1 to 6 and Comparative Examples 1 to 8, an analysis was performed with EDS, and the results thereof are shown in Table 2.

For the component content analysis, each of the thermal spray coating films was cut in a plane perpendicular to the surface of the substrate, and each of the obtained cross-section was embedded in resin and polished. Then, each of the cross-sectional images was measured with EDS using an electron microscope (manufactured by JEOL, JS-6010). During the EDS measurement, each of the components was identified through a sample whose CPS level was confirmed to be over 100,000 counts for 1 min.

### Experimental Example 2: Measurement of Porosity of Thermal Spray Coating Film

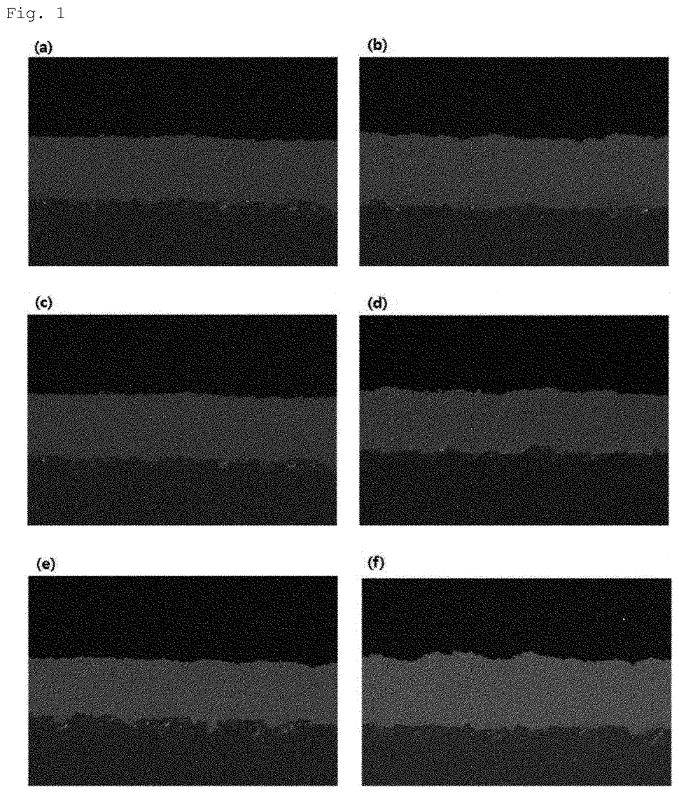

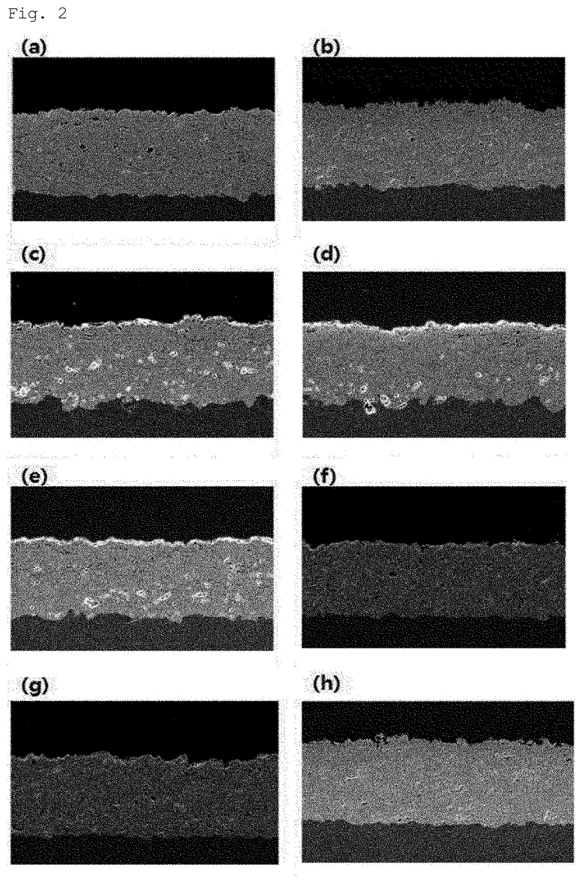

In order to compare a porosity of thermal spray coating film according to the present invention and a porosity of each of the thermal spray coating films manufactured in Comparative Examples, each of the thermal spray coating films manufactured in Examples 1 to 6 and Comparative Examples 1 to 8 was cut in a plane perpendicular to the surface of the substrate, and each of the obtained cross-sections was embedded in resin and polished. Then, each of the cross-sectional images was measured with EDS using an electron microscope (manufactured by JEOL, JS-6010) (FIGS. 1 and 2).

By analyzing the images using image analysis software (manufactured by MEDIA CYBERNETICS, Image Pro), each area of the portion having pores in the cross-sectional images was specified. Each porosity of the thermal spray coating film was measured by calculating the ratio of the area of the portion having pores to the total cross-section area, and the results are shown in Table 2.

### Experimental Example 3: Measurement of Crystal Structure of Thermal Spray Coating Film

A crystal structure of each of the thermal spray coating films manufactured in Examples 1 to 6 and Comparative Examples 1 to 8 was measured by an analysis of X-ray diffraction pattern (Multipurpose X-ray Diffractometer), and the results are shown in Table 2.

### Experimental Example 4: Measurement of Hardness of Thermal Spray Coating Film

A Vickers hardness of each of the thermal spray coating films manufactured in Examples 1 to 6 and Comparative Examples 1 to 8 was measured, and the results are shown in Table 2.

For the measurement of the Vickers hardness, a micro hardness tester (manufactured by MITUTOYO, HM 810-124K) was used and each of the Vickers hardness (Hv0.2) obtained when a test force of 294.2 mN was applied by a diamond indenter at a face angle of 136° was measured.

TABLE 2

| | | | Component content of | | | |
|---|---|---|---|---|---|---|
| | | | thermal spray coating | | | |
| | Porosity | Hardness | film (weight %) | | | |
| Classification | (%) | (Hv) | Y | O | F | Crystal Structure |
| Example 1 | 0.88 | 498 | 52.85 | 3.53 | 43.64 | Yttrium Oxide (Monoclinic) |
| | | | | | | Yttrium Oxide (Cubic) |
| | | | | | | Yttrium Fluoride |
| | | | | | | (Orthorhombic) |
| | | | | | | Yttrium Oxide Fluoride |
| | | | | | | (Orthorhombic) |
| Example 2 | 1.701 | 455 | 49.08 | 2.81 | 48.11 | Yttrium Oxide (Monoclinic) |
| | | | | | | Yttrium Oxide (Cubic) |
| | | | | | | Yttrium Fluoride |
| | | | | | | (Orthorhombic) |
| | | | | | | Yttrium Oxide Fluoride |
| | | | | | | (Orthorhombic) |
| Example 3 | 1.714 | 469 | 44.05 | 1.45 | 54.49 | Yttrium Oxide (Monoclinic) |
| | | | | | | Yttrium Oxide (Cubic) |
| | | | | | | Yttrium Fluoride |
| | | | | | | (Orthorhombic) |
| | | | | | | Yttrium Oxide Fluoride |
| | | | | | | (Orthorhombic) |
| Example 4 | 1.81 | 495 | 50.04 | 4.50 | 45.46 | Yttrium Oxide (Monoclinic) |
| | | | | | | Yttrium Oxide (Cubic) |
| | | | | | | Yttrium Oxide Fluoride |
| | | | | | | (Orthorhombic) |
| | | | | | | Yttrium Oxide Fluoride |
| | | | | | | (Rhombohedral) |
| Example 5 | 1.84 | 453 | 44.77 | 3.32 | 55.91 | Yttrium Oxide (Monoclinic) |
| | | | | | | Yttrium Oxide (Cubic) |
| | | | | | | Yttrium Oxide Fluoride |
| | | | | | | (Orthorhombic) |
| Example 6 | 1.58 | 528 | 39.69 | 1.86 | 58.44 | Yttrium Oxide (Monoclinic) |
| | | | | | | Yttrium Oxide (Cubic) |
| | | | | | | Yttrium Oxide Fluoride |
| | | | | | | (Orthorhombic) |
| | | | | | | Yttrium Oxide Fluoride |
| | | | | | | (Rhombohedral) |
| Comparative | 2.62 | 387 | 56.32 | 39.63 | 4.05 | Yttrium Oxide (Cubic) |
| Example 1 | | | | | | Yttrium Oxide Fluoride |
| | | | | | | (Orthorhombic) |
| Comparative | 2.67 | 355 | 86.15 | 5.36 | 8.49 | Yttrium Oxide (Cubic) |
| Example 2 | | | | | | Yttrium Fluoride |
| | | | | | | (Orthorhombic) |
| | | | | | | Yttrium Oxide Fluoride |
| | | | | | | (Orthorhombic) |
| Comparative | 4.95 | 426 | 67.00 | 9.00 | 24.01 | Yttrium Oxide (Cubic) |
| Example 3 | | | | | | Yttrium Fluoride |
| | | | | | | (Orthorhombic) |
| | | | | | | Yttrium Oxide Fluoride |
| | | | | | | (Orthorhombic) |
| Comparative | 5.99 | 439 | 63.76 | 8.22 | 28.02 | Yttrium Oxide (Cubic) |
| Example 4 | | | | | | Yttrium Fluoride |
| | | | | | | (Orthorhombic) |
| | | | | | | Yttrium Oxide Fluoride |
| | | | | | | (Orthorhombic) |
| Comparative | 5.85 | 430 | 65.07 | 8.27 | 26.67 | Yttrium Oxide (Cubic) |
| Example 5 | | | | | | Yttrium Fluoride |
| | | | | | | (Orthorhombic) |
| | | | | | | Yttrium Oxide Fluoride |
| | | | | | | (Orthorhombic) |
| Comparative | 3.99 | 391 | 83.80 | 3.55 | 15.65 | Yttrium Oxide (Cubic) |
| Example 6 | | | | | | Yttrium Fluoride |
| | | | | | | (Orthorhombic) |
| | | | | | | Yttrium Oxide Fluoride |
| | | | | | | (Orthorhombic) |
| Comparative | 4.02 | 388 | 81.12 | 8.44 | 10.45 | Yttrium Oxide (Cubic) |
| Example 7 | | | | | | Yttrium Fluoride |
| | | | | | | (Orthorhombic) |
| | | | | | | Yttrium Oxide Fluoride |
| | | | | | | (Orthorhombic) |
| Comparative | 2.87 | 363 | 50.58 | 3.06 | 46.36 | Yttrium Oxide (Cubic) |
| Example 8 | | | | | | Yttrium Fluoride |
| | | | | | | (Orthorhombic) |
| | | | | | | Yttrium Oxide |
| | | | | | | Fluoride(Orthorhombic) |

As shown in Table 2 and FIGS. 1 and 2, each of the thermal spray coating films manufactured in Examples 1 to 6 showed a porosity in a range of 0.88% to 1.84% while each of the thermal spray coating films manufactured in Comparative Examples 1 to 8 showed a porosity in a range of 2.62% to 5.99%. As a result, it was confirmed that the thermal spray coating films manufactured in Examples 1 to 6 had a superior density compared to the thermal spray coating films manufactured in Comparative Examples 1 to 8. In addition, each of the thermal spray coating films manufactured in Examples 1 to 6 showed a hardness in a range of 453 Hv to 528 Hv while each of the thermal spray coating films manufactured in Comparative Examples 1 to 8 showed a hardness in a range of 355 Hv to 439 Hv. As a result, it was confirmed that the thermal spray coating films manufactured in Examples 1 to 6 also had a superior durability compared to the thermal spray coating films manufactured in Comparative Examples 1 to 8.

On the other hand, in the case of the thermal spray coating films manufactured in Examples 1 to 6, the thermal spray coating films having various crystal structures could be manufactured depending on the mixing ratio of the thermal spray powder. However, in the case of the thermal spray coating films manufactured in Comparative Examples 1 to 8, even though the mixing ratio of the thermal spray powder was changed, the cubic crystal structure, the orthorhombic crystal structure, and the orthorhombic crystal structure were only exhibited. As a result, it was confirmed that the thermal spray coating films manufactured in Comparative Examples 1 to 8 could not be used properly in various environments in which plasma resistance is required.

Therefore, when the thermal spray coating film is manufacture, it was confirmed that the slurry composition for suspension plasma thermal spray and the coating method, according to the present invention, can be stably applied to a corrosive environment because the ratio of an oxygen component and a fluorine component contained in the thermal spray coating film does not change. In addition, the slurry composition and the coating method enables formation of various crystal structures under control, thereby being applicable to various environments in which corrosion resistance is required, and inhibits generation of cracks and pores that generally occurred in conventional thermal spray coating films, thereby enabling formation of a denser thermal spray coating film than conventional thermal spray coating films.

1. A slurry composition for suspension plasma thermal spray, the slurry composition comprising a solvent and a thermal spray powder,
wherein the thermal spray power is selected from the group consisting of:
a thermal spray powder comprising a Y₂O₃ powder and a YF₃ powder;
a thermal spray powder comprising a Y₂O₃ powder and a YOF powder;
a thermal spray powder comprising a YF₃ powder and a YOF powder; and
a thermal spray powder comprising a Y₂O₃ powder, a YF₃ powder, and a YOF powder,
wherein when the thermal spray powder comprises the Y₂O₃ powder and the YF₃ powder, the weight ratio thereof is in a range of 1:0.1 to 9,
when the thermal spray powder comprises the Y₂O₃ powder and the YOF powder, the weight ratio thereof is in a range of 1:0.1 to 9,
when the thermal spray powder comprises the YF₃ powder and the YOF powder, the weight ratio thereof is in a range of 1:0.1 to 9, and
when the thermal spray powder comprises the Y₂O₃ powder, the YF₃ powder, and the YOF powder, the weight ratio thereof is in a range of 1:0.1 to 9:0.1 to 9.

2. The slurry composition of claim 1, wherein the solvent and the thermal spray powder are comprised in a weight ratio of 100 parts of the solvent to 10 to 50 parts of the thermal spray powder.

3. The slurry composition of claim 1, wherein the thermal spray powder has an average particle size in a range of 100 nm to 10 μm.

4. The slurry composition of claim 1, wherein the solvent comprises at least one selected from the group consisting of water, alcohol, ether, ester, and ketone.

5. A method for preparing a slurry composition for suspension plasma thermal spray, the method comprising:
(a) dispersing each of at least two kinds of powders selected from the group consisting of a Y₂O₃ powder, a YF₃ powder, and a YOF powder into a solvent to obtain two or more kinds of dispersions; and
(b) mixing the two or more kinds of dispersions,
wherein in the (b) mixing, the mixing weight ratio is in a range of 1:0.1 to 9 when the two or more kinds of dispersions are a Y₂O₃ dispersion and a YF₃ dispersion,
the mixing weight ratio is in a range of 1:0.1 to 9 when the two or more kinds of dispersions are a Y₂O₃ dispersion and a YOF dispersion,
the mixing weight ratio is in a range of 1:0.1 to 9 when the two or more kinds of dispersions are a YF₃ dispersion and a YOF dispersion, and
the mixing weight ratio is in a range of 1:0.1 to 9:0.1 to 9 when the two or more kinds of dispersions are a Y₂O₃ dispersion, a YF₃ dispersion, and a YOF dispersion.

6. The method of claim 5, wherein in the (a) dispersing, a weight ratio of the solvent to the powder is 100 parts to 10 to 50 parts.

7. The method of claim 5, wherein in the (a) dispersing, the powders have an average particle size in a range of 100 nm to 10 μm.

8. The method of claim 5, wherein in the (a) dispersing, the solvent comprises at least one selected from the group consisting of water, alcohol, ether, ester, and ketone.

9. A suspension plasma thermal spray coating film formed by suspension plasma thermal spray using the slurry composition of claim 1.

10. The suspension plasma thermal spray coating film of claim 9, wherein the suspension plasma thermal spray coating film comprises 10% to 60% by weight of yttrium (Y), 1% to 20% by weight of oxygen (O), and 20% to 70% by weight of fluorine (F) with respect to a total weight of all of the elements constituting the coating film.

11. The suspension plasma thermal spray coating film of claim 9, wherein the suspension plasma thermal spray coating film has a thickness in a range of 10 μm to 200 μm.

12. The suspension plasma thermal spray coating film of claim 9, wherein the suspension plasma thermal spray coating film has a porosity of less than 2% measured according to ASTM E2109.

13. The suspension plasma thermal spray coating film of claim 9, wherein the suspension plasma thermal spray coating film comprises a monoclinic crystal structure and/or a rhombohedral crystal structure.
